(19) United States
(12) Patent Application Publication
(10) Pub. No.: US 2004/0080195 A1
(43) Pub. Date: Apr. 29, 2004

(54) Mechanical attachment of anchorage and bracket

(75) Inventors: Grant A. Adams, Livonia, MI (US); Joseph M. Kish, Brownstown, MI (US); Ashok K. Sethi, Ann Arbor, MI (US); Edward J. Lamont, Livonia, MI (US)

Correspondence Address: FOLEY & LARDNER, 150 WEST JEFFERSON AVENUE, SUITE 1000, DETROIT, MI, 48226-4443, US

(73) Assignee: Johnson Controls Technology Company

(21) Appl. No.: 10/281,549

(22) Filed: Oct. 28, 2002

(51) Int. Cl. B60N 2/28

(52) U.S. Cl. 297/253

(57) ABSTRACT

An anchorage for connecting an article such as a child safety seat to a vehicle seat includes a wire rod having rectangular shape and having first and second legs each terminating in a bent portion. A unitary attachment bracket is mechanically and weldlessly connected to the wire rod in a pressing operation wherein the attachment bracket includes retainer members aligned with the bent portions of the wire rod to prevent the bent portions from straightening when a load is applied to the wire rod. The attachment bracket connects the wire rod to a vehicle component. A method of producing the anchorage includes producing the wire rod and the attachment bracket blank and aligning them to weldlessly, mechanically capture the wire rod in the formed attachment bracket and then connect the anchorage to the vehicle component.

### CROSS-REFERENCE TO RELATED PATENT APPLICATIONS

The present application is related to the application titled Retainer and Wire Rod for Child Safety Seat Anchorage, to Tong, et al., filed______ application titled Mechanical Attachment of Anchorage and Bracket, to Medvecky, et al., filed______, which are incorporated herein by reference.

### FIELD OF THE INVENTION

The present invention relates generally to the field of anchoring an article such as a child safety seat to a vehicle seat. More particularly the present invention relates to a robust way of mechanically attaching a wire rod anchorage to the vehicle or vehicle seat.

### BACKGROUND OF THE INVENTION

Anchoring various articles to vehicle seats is becoming increasingly important as new products, rules, regulations and laws begin to transform prior practices. For example, until recently seats to be installed in a vehicle seat (hereinafter referred to as “child safety seats”) for infants, toddlers and small children were held in place using the available shoulder and lap belt which were, of course, designed for protection of much larger passengers. While the should and lap belt adequately secured the infant seat to the vehicle seat, due to design variations from vehicle to vehicle and from child safety seat to child safety seat, the efficacy of such systems were subject to the user's ability to properly install the infant seat.

Some modifications and standardization were incorporated into child safety seats such as providing belt notches to guide the factory installed belts across the child, and even as of the filing date of this specification, law enforcement personnel, child safety seat manufacturers, vehicle manufacturers and sellers, and various safety advocates are trying to inform parents and other child care givers about the best ways to attach child safety seats and snug or tighten them into compressive engagement with the vehicle seat's seat cushion and seat back.

In addition to child safety seats, it is also desirable to be able to securely attach other articles and devices to vehicle seats, e.g., play or activity centers, auto office products, and entertainment centers (such as those which employ VHS, DVD or CD input to a monitor or screen). While passengers do not occupy the space consumed by such products, it is important to ensure that such articles do not come loose and injure passengers, e.g., in the event of a severe impact.

In numerous foreign countries (e.g., Australia and Canada), and recently in the United States, a new system for child safety seat attachment has been developed and mandated for use. This system is known in the United States as L.A.T.C.H. (Lower Anchors and Tethers for Children). The system involves providing anchorage at the bite line of a vehicle seat (i.e., the area between the seat cushion and the seat back) to which straps, belts or a linkage from a child safety seat are attached. The Federal Motor Vehicle Safety Standards relating to Crash Worthiness as set forth in 49 C.F.R. Parts 571 and 596, which are incorporated herein by reference, require a pair of wire rod anchorage to be spaced apart from one another by a specific distance, and in use a child safety seat is placed on the seat cushion between them. In particular, it is required that the child safety seat anchorages be standardized and independent of the vehicle seat belts. Two straps secured to the child safety seat (or a single strap passing through the child safety seat) have hooks or other connectors attached to their free ends. The hooks are placed over the wire rods, and slack is taken out of the straps using length adjustment devices which, in and of themselves, are of the types used with passenger lap belts. The child safety seat is then held in place by a system which ultimately depends on the robustness of wire rods.

It can also be mentioned here that a third point of anchoring the child safety seat is also being required, namely a package shelf anchorage (for the rear seat of a vehicle which has a package shelf) or a third anchorage at the base of the back of a seat (such as captain, bucket, or bench seats in sport utility vehicles, vans and the like). The latter allows a third strap or tether attached to the top of a child safety seat to be secured to this third anchorage to assist in preventing forward tilting of the child safety seat in the event of an impact. The applicability of the present invention to such third anchorages will become apparent to those skilled in the art as the description of the background and the preferred and alternate embodiments of the invention continue.

The number of ways in which the wire rods used in the aforementioned system are construed varies widely, due to the style of seat and vehicle, and the available seat frame or vehicle frame locations for attachment of the wire rods are numerous. In most cases, however, the wire rods are attached by welding them to a seat frame or vehicle frame component such as a tube connected to the seat. The type of connection may also depend upon the type of seat that the anchorage is being connected such as a bench seat, a captain's chair or other alternative seat. Therefore, the robustness of the load bearing performance of the wire rod anchorage is dependent on many factors including the wire rod material, geometry, weld materials, weld design and workmanship, and many events subsequent to wire rod installation which could affect the integrity of the welds.

Several examples exist which demonstrate types and designs of connections for attaching a wire rod anchorage to a vehicle seat. For example, U.S. Pat. Nos. 6,354,648; 6,196,628; 6,030,046; 5,941,601; 5,918,934; 5,816,651; 6,361,115; 6390,560; and 6,276,754 all disclose a variety of designs for attaching an anchorage to a vehicle seat and all of which have significant drawbacks in that they either require the wire rod anchorage be directly welded to another seat device or they require a manufacturing process that is overly complex and costly.

It would be highly desirable in this art to use a system for installing the wire rod anchors which entirely eliminates the costs and mandated testing in a design having a weld between the wire rod and another component including the attendant issues with materials, design or workmanship. The benefit to the art would be further enhanced if any such system could be readily adapted to a wide variety of seat types and styles having a similar variety of support mechanisms and vehicle seat attachment configurations.

### SUMMARY OF THE INVENTION

One feature of the present invention relates to providing a unique design for attaching wire rod anchorages to a vehicle seat or frame component which relies entirely on a mechanical coupling to retain the wire rod.

Another feature of the present invention is to provide a design for mechanically coupling a wire rod anchorage to a vehicle seat or frame component wherein there is no weld applied to the wire rod.

A further feature of the present invention is to provide wire rod anchorages having improved reliability.

A different feature of the present invention is to provide a method for coupling a wire rod anchorage to a vehicle seat or frame which reduces assembly time and cost while producing a wire rod anchorage which is capable of meeting extremely high standards.

A still further feature of the present invention is to provide a wire rod anchorage having improved load transfer in the event of sudden change in acceleration from an unintended event such as an impact from an accident.

Generally, the above features are accomplished by weldlessly, mechanically coupling a wire rod to a vehicle component such as a vehicle seat frame using a coupling or attachment bracket or member. A weld is only employed between the attachment bracket and the vehicle component to ensure proper orientation and location of the anchorage relative to the vehicle seat. With the mechanical coupling system of the present invention, the welds are not located in the load path. That is when a load is applied to the wire rod and transferred to the vehicle component, no weld touches the wire rod. Thus welds have no function in transferring loads from the child safety seat (or other article) to the vehicle component or seat frame.

In one embodiment of the present invention, a wire rod is formed to have a generally rectangular shape having a connecting portion and first and second legs each having a bent portion. The bent portion of each leg of the wire rod is preferably located on one side of the rectangular shaped wire rod and is aligned with and opposing the other bent portion. The wire rod is preferably coplanar.

In one embodiment of the present invention, the attachment bracket is shaped to conform with and mechanically lock to at least a portion of the wire rod. The attachment bracket has a middle portion and first and second side portions. Each side portion includes at least a straight portion for wrapping and capturing the wire rod. The attachment bracket further includes a wing for connecting the attachment bracket to the vehicle component. In one preferred embodiment, each wing includes a hole for attachment with a tube of a vehicle seat frame. In alternate embodiments, other types and kinds of connections may be made between the attachment bracket and the vehicle component.

In one embodiment of the present invention the attachment bracket further includes a lower portion including at least one retaining member. The retaining member is aligned with the bent end of the wire rod to prevent the bent end from straightening when a load is applied to the wire rod.

The attachment bracket further includes first and second wall portions aligned with the middle portion, the lower portion and the first and second side portions to define first and second passages. The bent ends of the first and second legs of the wire rod extend in the first and second passages, respectively. The wall portions are aligned with corners of the wire rod to capture the bent ends and prevent the wire rod from being pulled from the attachment bracket. The retaining member of the lower portion of the attachment bracket prevents the bent ends from bending straight in response to being forced against the wall portion. The retaining member of the lower portion in one embodiment of the present invention is a distorted or formed portion of the lower portion of the attachment bracket which extends in one direction from the generally flat planar configuration of the attachment bracket.

In one particularly preferred embodiment of the present invention, the attachment bracket is unitary and is made by stamping or otherwise forming a generally flat planar piece of metal into a blank. Separately, the wire rod is bent or otherwise formed into a substantially rectangular shape. Next, the wire rod and the blank are preferably inserted, simultaneously or sequentially, into a press machine and then pressed together wherein the blank is formed into the attachment bracket and captures and weldlessly, mechanically locks the wire rod to the attachment bracket. In one aspect of the present invention, a first and second side portions of the blank constituting the attachment bracket are wrapped around the first and second legs of the wire rod to form straight portions of the first and second side portions of the attachment bracket. In one embodiment of the present invention, after the blank is pressed and formed to mechanically lock with the wire rod, the straight portions of the attachment bracket are staked to the first and second legs of the wire rod to prevent movement of the wire rod with respect to the attachment bracket.

Other ways in which the above-referenced features and advantages of the present invention are accomplished will become apparent to those skilled in the art after they have read this specification and the drawings. Such other ways are deemed by the inventors to fall within the scope of the present invention if they fall within the scope of the claims which follow.

### BRIEF DESCRIPTION OF THE DRAWINGS

In the FIGURES, like reference numerals will be used to designate like components, wherein:

FIG. 1 is a perspective view of a child safety seat anchorage according to the present invention showing bracket designed for connection to a round circumference surface, such as a tube;

FIG. 2 is an alternate perspective view of the child safety seat anchorage of FIG. 1;

FIG. 3 is a partial sectional view of the child safety seat anchorage of FIG. 1 detailing the relationship between the wire rod and the bracket according to the present invention;

FIG. 4 is a partial sectional view of the child safety seat anchorage according to the present invention taken along the line 4-4 in FIG. 1;

FIG. 5 is a perspective view of a vehicle seat component having a pair of child safety seat anchorages connected thereto; and

FIG. 6 is an alternate perspective view of the seat anchorages and vehicle seat component of FIG. 5 according to the present invention.

### DETAILED DESCRIPTION OF THE PREFERRED EMBODIMENTS

Initially provided are several general comments about the applicability and scope of the present invention. First, the materials used for the wire rods and other structural components shown in the FIGURES can be selected from those known to the art, including steel, various other alloys, or high strength metals such as stainless steel and steel alloys. In particular, the wire rod is preferably made of steel consistent with ASTM A510 standard, steel grade 1018 which is reduction hardened to have a minimum yield strength of at least 80 k.s.i. using any known or appropriate manufacturing process or what may be mandated by other regulation or standard.

Second, the number of anchorages will vary with the type of vehicle, application and seat design. The spacing between a pair of anchorages remains substantially constant according to standards and regulations but may be of any known or appropriate distance. There will typically be a single pair of anchorage for a given passenger seat. Thus, for a bench seat having multiple passenger seats, two or three pairs of seat anchorage may be included. Further, it should be noted that the particular syntax and usage of the term anchorage herein is intended to be interpreted as appropriately applicable to either a given passenger seat and a given child safety seat or a plurality of same regardless of the correct grammatical context.

Third, the mechanical attachment feature of the present invention is primarily illustrated in connection with a seat bite line anchorage. It is understood that any anchorage for a vehicle seat, including a tether anchorage, can also benefit from the teachings set forth herein.

Fourth, the child safety seat anchorage illustrated is intended for use with passenger vehicles, such as automobiles, light trucks, sport utility vehicle, vans and the like. However, the principles of the present invention are readily adaptable to install anchorages at other locations within vehicle as well in any appropriate application including such as in airplanes, trains, buses and even in strollers with detachable seats.

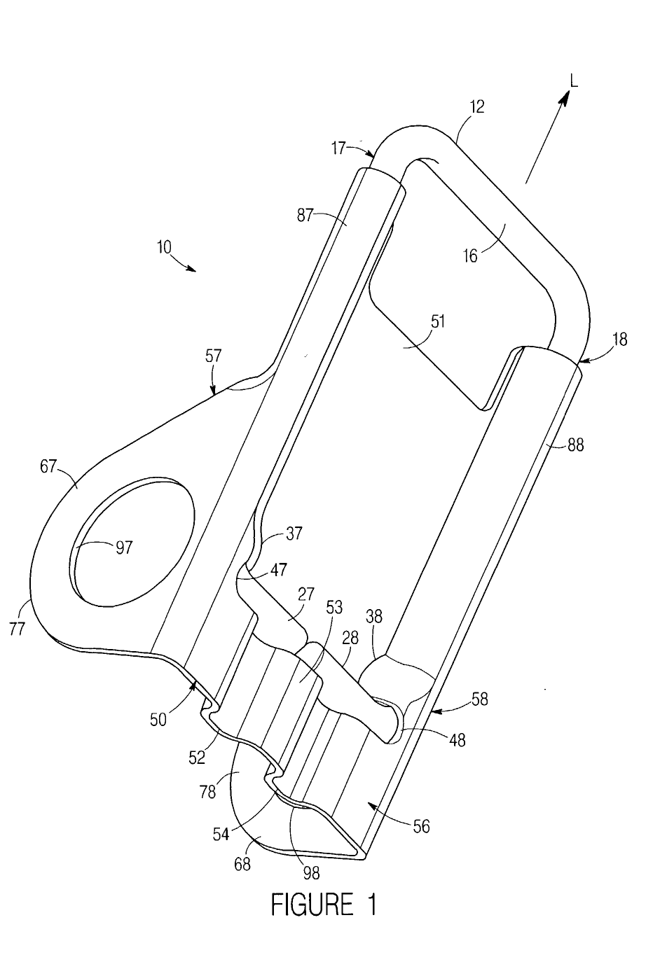

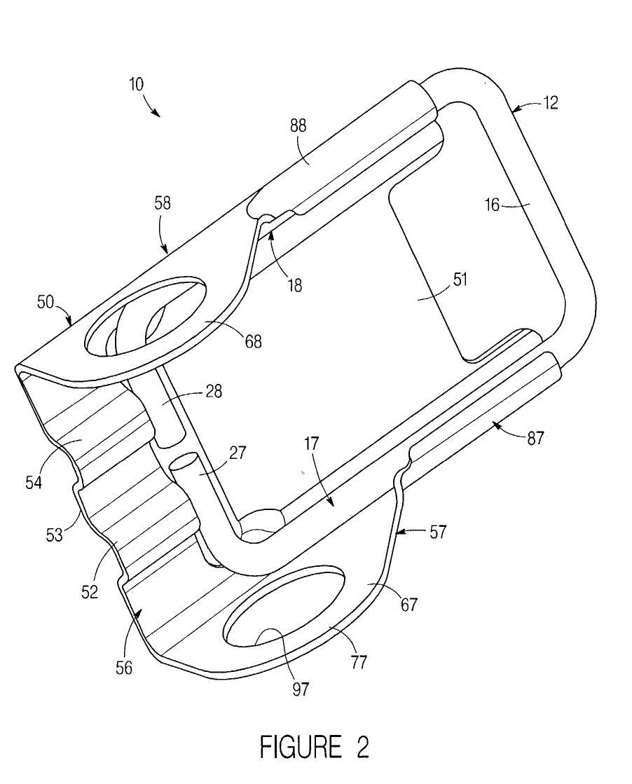

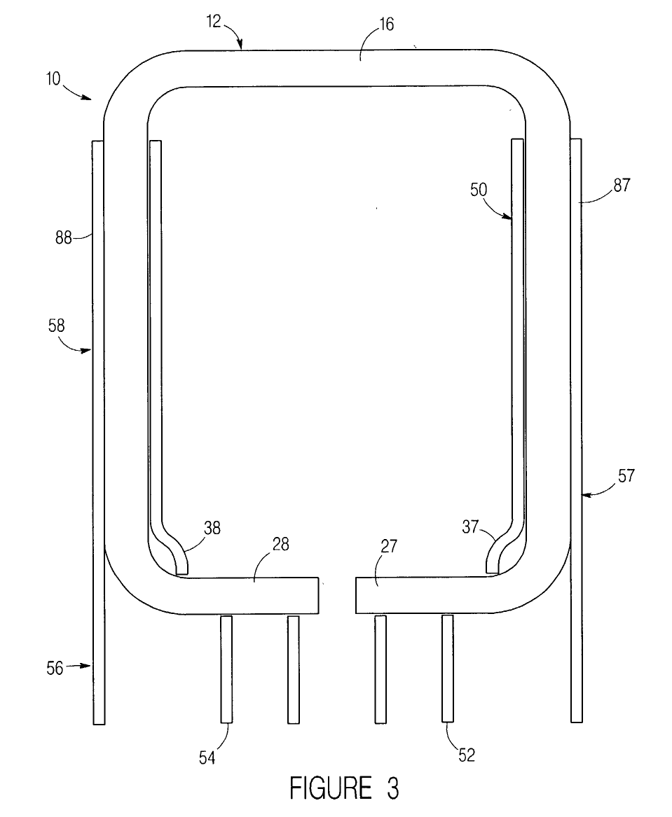

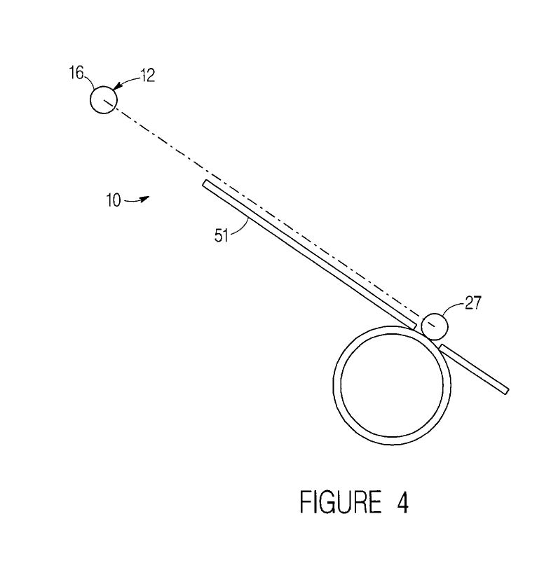

Proceeding now to the description of FIGS. 1-6 in general and more particularly FIGS. 1-3, there is shown an anchorage 10 for connecting a child safety seat or other article (not shown) to a vehicle seat or frame component. The anchorage 10 has two main components in the form of a wire rod 12 and an attachment bracket 50.

The wire rod 12 is bent into a substantially rectangular shape having four sides and four corners. The wire rod 12 has a middle or connection portion 16 for connection with the child safety seat or other article. First and second leg portions 17 and 18 connect with the middle portion 16 at corners and are preferably aligned coplanar with the middle portion 16. The wire rod 12 further includes first and second bent portions 27 and 28 connected with the first and second legs 17 and 18, respectively. The bent portions 27 and 28, the first and second legs 17 and 18 and the middle portion 16 are preferably all unitary and constitute the wire rod 12. However, it should be understood that it is possible to have the bent portions 27 and 28, the first and second legs 17 and 18 and the middle portion 16 made into an integral wire rod 12.

In the preferred embodiment, the wire rod 12 is made of a single piece of metal and is bent into a substantially rectangular shape having the two ends of the wire rod 12 aligned and nearly touching on one side of the rectangle. In this embodiment, the wire rod 12 is preferably entirely co-planar. It is possible to have the bent portions 27 and 28 of the wire rod 12 bent in a direction such that they are not coplanar with the rest of the wire rod 12. In this embodiment, the wire rod 12 would be substantially U-shaped.

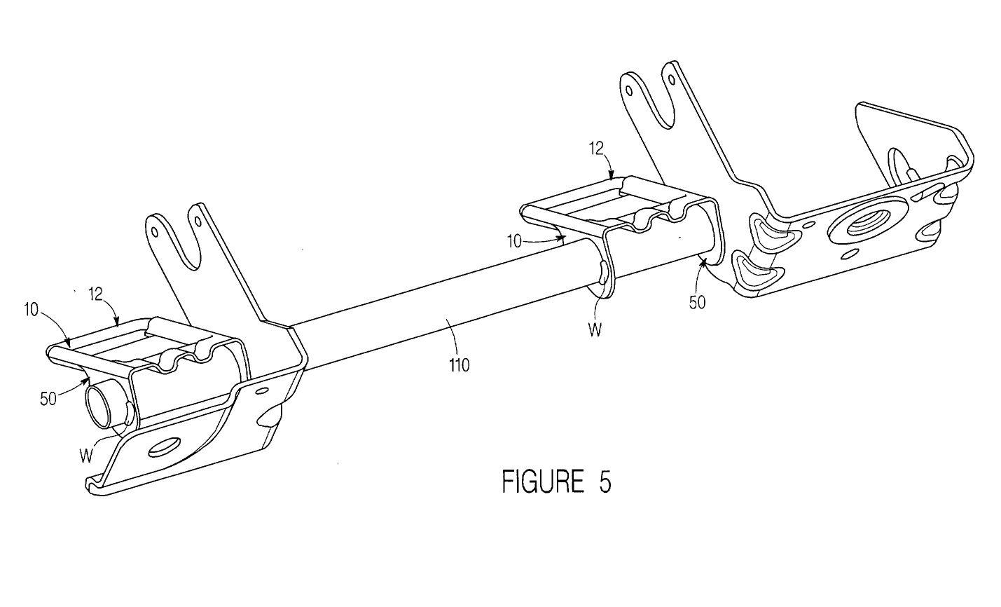

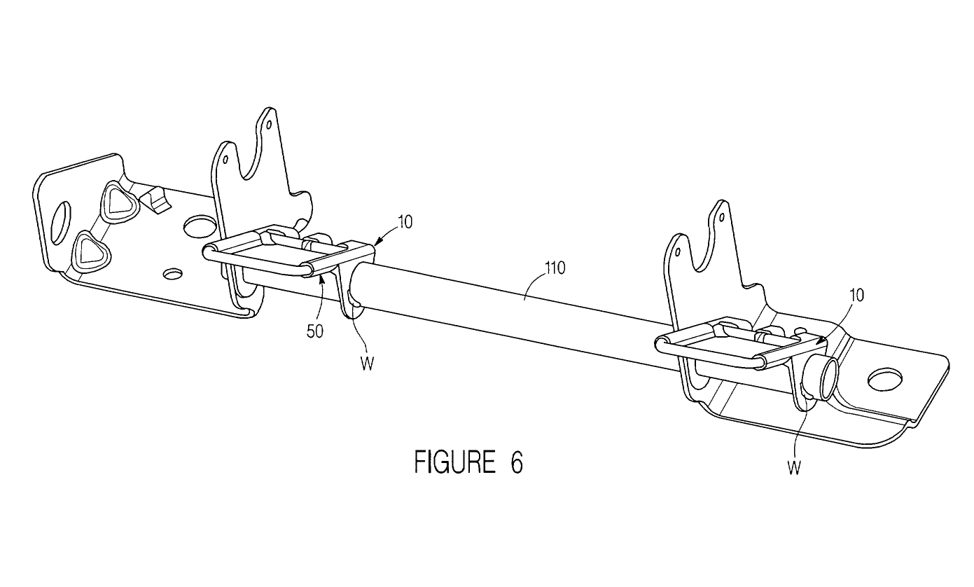

The attachment bracket 50 is preferably made from a single, unitary piece of steel material that is stamped and folded to connect with and capture the wire rod 12. The attachment bracket 50 includes a main body portion 51 and a first side portion 57 and a second side portion 58 spaced from the first side portion 57 and the main body portion 51 being located there between. The first side portion 57 has a wing 67 having a first curvilinear shape portion 77 and a second straight portion 87. The first side portion 57 has a passage or hole 97 therein preferably in the wing 67. The second side portion 58 has a wing 68 having a first curvilinear shape portion 78 and a second straight portion 88. The second side portion 58 has a passage or hole 98 therein preferably in the wing 68. The holes 97 and 98 of the first and second side portions 57 and 58, respectively, preferably have aligned centers such that the holes 97 and 98 will fit on a straight tube 110, as best shown in FIGS. 5 and 6. However, it is possible to have the holes 97 and 98 offset or to have alternative shapes without departing from the broader aspects of the present invention. Similarly, while the first and second side portions 57 and 58, respectively, are preferably mirror images along a center line of the wire rod 12, it is possible to provide unique features and characteristic to only one of the side portions 57 and 58 without departing from the broader aspects of the present invention.

Each of the first and second side portions 57 and 58, have a first and second wall portions 37 and 38, respectively, at the interface of the main body portion 51 and the lower ends of the first and second straight portions 87 and 88 and the lower portion 56. The intersections of these parts defines first and second passages 47 and 48 in which the legs 17 and 18 of the wire rod 12 are located.

The lower portion 56 of the attachment bracket 50 includes first and second retaining members 52 and 54 aligned with the bent portions 27 and 28 of the wire rod 12. The retaining members 52 and 54 are preferably unitary with the main portion 51 and first and second side portions 57 and 58 but may alternatively be made separately and then integrated into the attachment bracket 50. The retaining members 52 and 54 are portions of the attachment member 50 that are distorted to a side of the attachment member 50 first from being aligned with the main body portion 51. A third retaining member 53, located between the retaining members 52 and 54, is also distorted to an opposite side from being aligned, with the main body portion 51.

While three retaining members are disclosed as being preferable, it is possible to provide any number of retaining members and to provide a variety of shapes to the members without departing from the broader aspects of the present invention. The retaining members 52, 53 and 54 function to retain the bent portions 27 and 28 from straightening or pulling through the passages 47 and 48.

As can be seen best in FIGS. 5 and 6, the holes 97 and 98 connect the attachment bracket 50 to a tube 110 or other component of a vehicle seat or frame 120. Thus, the attachment bracket 50 is anchored with the vehicle seat or frame 120. When a sufficient load, having a component of force in the direction of the arrow L (see FIG. 1), is applied to the wire rod 12 causing it to be pulled from the attachment bracket 50, the bent portions 27 and 28 located in the passages 47 and 48, contact the first and second wall portions 37 and 38, respectively, of the attachment bracket 50.

The force applied to the connection portion 16 of the wire rod 12 is constrained to act linearly along the legs 17 and 18 due to the straight portions 87 and 88 defining a channels on each of the first and second side portions 57 and 58 of the attachment bracket 50. Thus, when the bent portions 27 and 28 encounter the wall portions 37 and 38, the bent portions 27 and 28 are forced in a direction opposite of the arrow L toward the retaining member 52, 53 and 54. The retaining members 52, 53 and 54 prevent the bent portions 27 and 28 from bending or straightening and pulling out of the passages 47 and 48 and prevents the wire rod 12 from being pulled from the attachment bracket 50. Thus, the wire rod 12 is mechanically locked to the attachment bracket 50 without the need for any weld of any kind between the wire rod 12 and any other element, including in particular the attachment bracket 50. This is particularly significant since pursuant to current regulations if there is no weld touching the wire rod 12, it must not be production tested prior to installation in a vehicle thereby realizing significant savings.

Notwithstanding the above, it is desirable to have a weld “W” between the attachment bracket 50 and the tube 110 in the vicinity of the holes 97 and 98 to prevent rotation of the attachment bracket 50 and the wire rod 12 on the tube 110, as shown in FIG. 5.

The attachment bracket 50 is preferably made by first producing a flat blank metal piece generally having the features and characteristics such as the wings 67 and 68, holes 97 and 98 and straight portions 87 and 88. It is preferable to have the blank produced using a metal stamping operation but any other known method of manufacturing a blank, such as by cutting or molding, may be used.

Separately, and either simultaneously or sequentially, the wire rod 12 is produced as a straight piece of stock and then bent or otherwise formed into the substantially rectangular shape having the middle portion 16 and legs 17 and 18 and having the bent portions 27 and 28 opposing one another on one side thereof. Any other known or appropriate alternative method for manufacturing the metal rod 12 may be used.

After the metal rod 12 and the blank for the attachment bracket 50 are manufactured, they are both preferably placed either simultaneously or sequentially in a press machine. Further, the metal rod 12 and the attachment bracket 50 are aligned with respect to each other such that when the press machine is activated, the flat blank constituting the attachment bracket 50 will be formed around the metal rod 12. Thus, in the preferred embodiment of the present invention, the attachment bracket 50 is given its final shape and the wire rod 12 is simultaneously captured therein.

In this step, the first and second side portions 57 and 58 are made and the wing 67 and 68 are bent to be substantially perpendicular with the main portion 51 and the wall portions 37 and 38 and the straight portions 87 and 88 are formed to wrap the legs 17 and 18 of the wire rod 12. Further, the bent portions 27 and 28 are aligned with the lower portion 56 and the retaining members 52, 53, and 54. In the preferred embodiment of the present invention, the retaining members 52, 53 and 54 are formed during the forming of the blank of the attachment bracket 50. Alternatively, the retaining members 52, 53 and 54 are formed at the same time that the blank of the attachment bracket 50 is formed to capture and wrap the wire rod 12.

It is also desirable to provide other processing of the components of the anchorage 10. Such further processing may be done sequentially or simultaneously with the other steps of the method of manufacturing and include the metal hardening and finish coating components as well further fixing or attaching the attachment bracket 50 to the wire rod 12 such as by staking or pressing the straight portions 87 and 88 with the legs 17 and 18 of the wire rod 12.

While an embodiment of the present invention has been described in connection with the illustrations, and various, modifications thereto have been referred to in the written text, the present invention relates to the mechanical attachment of a child safety seat anchorage to various support structures, and the shift away from using any weld touching the mandated wire rod. Accordingly, the present invention may be variously embodied using this basic principle without departing from its intended scope. The invention is therefore not to be limited to the materials, shapes, orientations and proportions illustrated and described, but it is to be limited solely by the scope of the claims which follow.

What is claimed is:

1. An anchorage for connecting a child safety seat to a vehicle component, the anchorage comprising:
a wire rod having a connection portion and first and second legs, one of the first and second legs having a bent portion; and
an attachment member for capturing the wire rod and for connection with the vehicle component, the attachment member comprising:
a main portion located between a first portion capturing the first leg of the wire rod and a second portion capturing the second leg of the wire rod; and
a retaining member aligned with the bent portion of the wire rod to prevent the bent portion from straightening when a load is applied to the connection portion of the wire rod.

2. The anchorage of claim 1, wherein the wire rod has a rectangular shape and the first and second legs and the bent portion are coplanar.

3. The anchorage of claim 1, wherein the wire rod has a rectangular shape and is coplanar.

4. The anchorage of claim 1, wherein the wire rod is coplanar.

5. The anchorage of claim 2, wherein the attachment bracket is unitary.

6. The anchorage of claim 1, wherein the attachment member is unitary and the retainer member is a distorted portion of the attachment member extending in a direction from a side of the attachment member.

7. The anchorage of claim 1, wherein the attachment member is unitary and comprises at least two retainer members in a distorted portion of the attachment member and extending therefrom.

8. The anchorage of claim 7 wherein the at least two retainer members all extend from the same side of the attachment member.

9. The anchorage of claim 1, wherein the attachment member is unitary and comprises two retainer members in a distorted portion of the attachment member, the two retainer members extend from opposite sides of the attachment member.

10. An anchorage for connecting a child safety seat to a vehicle component, the anchorage comprising:
a wire rod having a connection portion and first and second legs, one of the first and second legs having a bent portion; and
an attachment member weldlessly connected with the wire rod, the attachment member adapted for connection with the vehicle component.

11. The anchorage of claim 10, wherein the wire rod has a rectangular shape and the first and second legs and the bent portion are coplanar.

12. The anchorage of claim 10, wherein the wire rod has a rectangular shape and is coplanar.

13. The anchorage of claim 10, wherein the wire rod is coplanar.

14. The anchorage of claim 11, wherein the attachment bracket is unitary.

15. The anchorage of claim 1, wherein the attachment member is unitary and the retainer member is a distorted portion of the attachment member extending in a direction from a side of the attachment member.

16. The anchorage of claim 15, wherein the attachment member is unitary and comprises two retainer members in a distorted portion of the attachment member, the two retainer members extend from opposite sides of the attachment member.

17. A method of manufacturing an anchorage for connecting an article to a vehicle component, the method comprising the steps of:
producing a wire rod having middle portion, first and second legs each terminating in a bent portion;
producing an attachment bracket for capturing the wire rod and connecting the wire rod to the vehicle component;
mechanically locking the attachment bracket to the wire rod; and
not welding the wire rod.

18. The method of claim 17, wherein the step of producing the attachment bracket and the step of mechanically locking the attachment bracket to the wire rod occur simultaneously.

19. The method of claim 17, wherein the step of producing the attachment bracket and the step of mechanically locking the attachment bracket to the wire rod occur sequentially.

20. The method of claim 17, further comprising the step of connecting the anchorage to the vehicle component.

21. The method of claim 17, further comprising the step of welding the attachment member to the vehicle component.

22. A method of manufacturing an anchorage for connecting an article to a vehicle component, the method comprising the steps of:
producing a wire rod having a middle portion and first and second legs;
producing an blank to be formed into an attachment bracket for capturing the wire rod and connecting the wire rod to the vehicle component;
mechanically locking the blank to the wire rod; and
not welding the wire rod.

23. The method of claim 22, wherein the step of mechanically locking the attachment bracket to the wire rod includes the steps of:
placing the wire rod and the blank in a machine; and
forming the blank to wrap at least a portion of the wire rod.

24. The method of claim 23, wherein the step of producing the metal rod includes the step of forming the metal rod to have a coplanar, rectangular shape and each leg has a bent end portion located on one side of the rectangular shape.

25. The method of claim 22, wherein the step of producing the metal rod includes the step of forming the metal rod to have a coplanar, rectangular shape and each leg has a bent end portion located on one side of the rectangular shape.

26. The method of claim 23, further comprising the step of staking the wrapped portion of the attachment bracket to the wire rod to prevent movement of the wire rod with respect to the attachment bracket.

27. The method of claim 22, further comprising the step of installing the anchorage on a vehicle component and locking the position and orientation of the anchorage with respect to the vehicle component.

28. The method of claim 27, wherein the vehicle component is a vehicle seat component and the method further comprises the step of welding the attachment bracket to the vehicle seat component.
